(19) United States
(12) Patent Application Publication
(10) Pub. No.: US 2017/0358893 A1
(43) Pub. Date: Dec. 14, 2017

(54) Power Strip Socket Availability Indicator

(71) Applicant: Jeff A. Wieland, Princeton, TX (US)

(72) Inventor: Jeff A. Wieland, Princeton, TX (US)

(21) Appl. No.: 15/177,635

(22) Filed: Jun. 9, 2016

(51) Int. Cl. H01R 13/717; H01R 25/16

(52) U.S. Cl. CPC H01R 13/7175; H01R 25/16

(57) ABSTRACT

This invention relates to a method for indicating availability for use of sockets of an electrical power strip.

### BACKGROUND

Typically, Power-strips are found in a variety of shapes and sizes and perform a variety of functions including usb sockets, integrated breakers, varied capacity 15A and greater, Power On light emitting diode indicator, Twistable and variable positioning of the sockets upon the power strip etc.

One item that has been overlooked is the ability to easily determine if another socket is available to plug into. For instance many power strips are located under desks, tables, or the like, and are difficult to access being behind various items against the wall they are plugged into.

When a need to use the power strip for another device arises, inspection and implementation to fulfill the need often requires getting down on the floor and crawl under a table, desk etc. or we might need to slide out a table or other piece of furniture to locate the power strip often to find there are no other sockets available to plug into.

There is a need to know if socket is available on the power strip prior to climbing under the desk or table.

### RELATED ART

Although, no device is currently specifically designed to meet said needs described in aforementioned Field of the Invention, provide a means for understanding usage and implementation to achieve the needs described above.

U.S. Pat. No. 9,252,537
Cox, et al. Feb. 2, 2016
Retaining an electrical cable to a power strip
U.S. Pat. No. 9,300,097 to Simonov”
Multi-function power strip
U.S. Pat. No. 9,277,630

### Braunstein Mar. 1, 2016

Apparatus intelligent parallel view LED light, methods of configuration and controls

These related arts provide a means to understanding usage and implementation to understanding claims. These related art refer to a devices used as a power strip and have advanced features. They and all others don't include claims and features described herein.

### SUMMARY OF THE INVENTION

This invention provides a major advantage for Power Strip implementation. It is an object of the present invention to provide a visible means upon a power strip indicating availability of socket status.

Another object of this invention is to provide some of many possible methods for activating or deactivating the S-LIGHT.

### DESCRIPTION OF DRAWING FIGURES

FIG. 1 is an illustration of an embodiment of a top view of a Power Strip to identifying various portions of a power strip. 1 is end A, 2 is end B, 3 is side A, 4 is side B, 5 is top, 6 cord, 7 plug.

FIG. 2 is an illustration of an embodiment of a bottom view of a Power Strip to identifying various portions of a power strip.

FIG. 3 is an illustration of an embodiment implementing a Power Strip Socket Availability Indicator having 6 S-LIGHT indicators.

FIG. 4 is an illustration of an embodiment implementing a Power Strip Socket Availability Indicator having S-LIGHT located on various areas including sides, ends, top, cord and plug.

FIG. 5 is an illustration of an embodiment implementing a Power Strip Socket Availability Indicator having an enlarged view of the ground pin and associated switch mechanism to open the S-LIGHT circuit.

FIG. 6 is an illustration of an embodiment implementing a Power Strip Socket Availability Indicator with multiple ground pin and associated switch mechanisms to open the S-LIGHT circuit and includes a lumen control method.

FIG. 7 is an illustration of an embodiment implementing a Power Strip Socket Availability Indicator with no available sockets for use.

FIG. 8 is an illustration of an embodiment implementing a Power Strip Socket Availability Indicator with available sockets for use and a lumen adjustment method.

### DESCRIPTION OF EMBODIMENTS

### Definitions

Active: Herein refers to S-LIGHT turning off.
Ground Pin: Portion of a plug designated as connecting to earth ground.
Neutral Pin: Portion of a plug designated as connecting to neutral.
Inactive: S-LIGHT indicating available sockets for use.
Active: S-LIGHT indicating no available sockets for use.
Light: Herein refers to any means of visible radiation.
Case: The outside portion of the power strip that provides a physical body and support for the sockets.

### S-LIGHT: Socket Light

Socket light: Herein refers to any type or types of visible radiation as a socket availability indicator.
Socket availability Indicator: Herein refers to visible light indication of an available socket.
Socket: Herein refers to the portion of the power strip that receives plug.
Outlet: (AKA Power Outlet) is at times used interchangeably with socket.
Power Cord: Herein refers to electric cabling used to connect power strip to power mains.
Power Strip: Herein refers to (AKA multi-plug adapters, re-locatable power taps, extension block, power board, power bar, plug board, trailing gang, trailing socket, trailer lead) a block of electrical sockets having a power cord connecting the block of electrical sockets to the mains plug allowing multiple electrical devices to be powered from a single electrical socket.
Plug: Herein refers to an end of a Power Cord that connects into a socket.
User: Herein refers to someone or something that uses a power strip.
Vacant: Herein refers to a socket not having an inserted plug.
Light Enhanced Power Strip: Herein refers to a power strip using an S-LIGHT to provide a visible indication of an available socket that a user may plug into.
Lumen: (AKA luminous or lumens), Herein refers to any quantity of visible light.

### System:

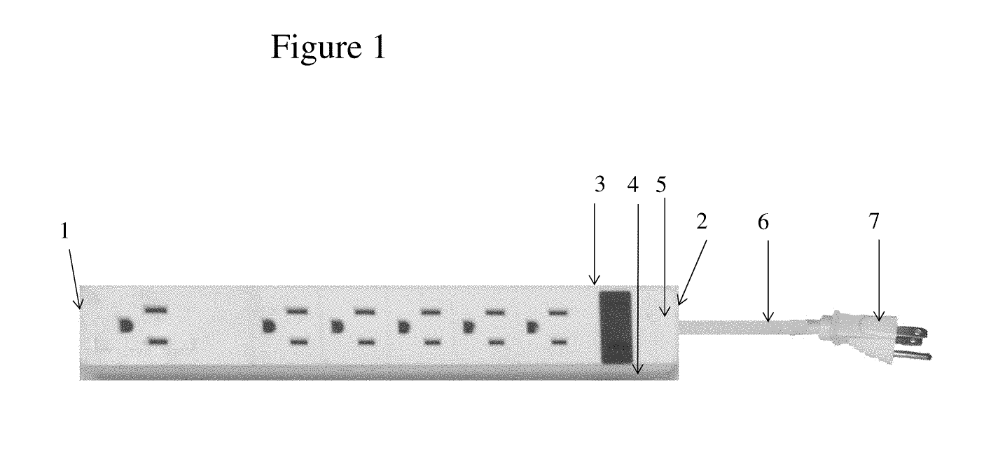

Referring to FIG. 1 of the drawings, for identification purposes, please locate the power strip showing items 1 and 2 being the ends of the power strip, Items 3 and 4 being the sides, item 5 being the top and item 6 being the cord and 7 being the plug.

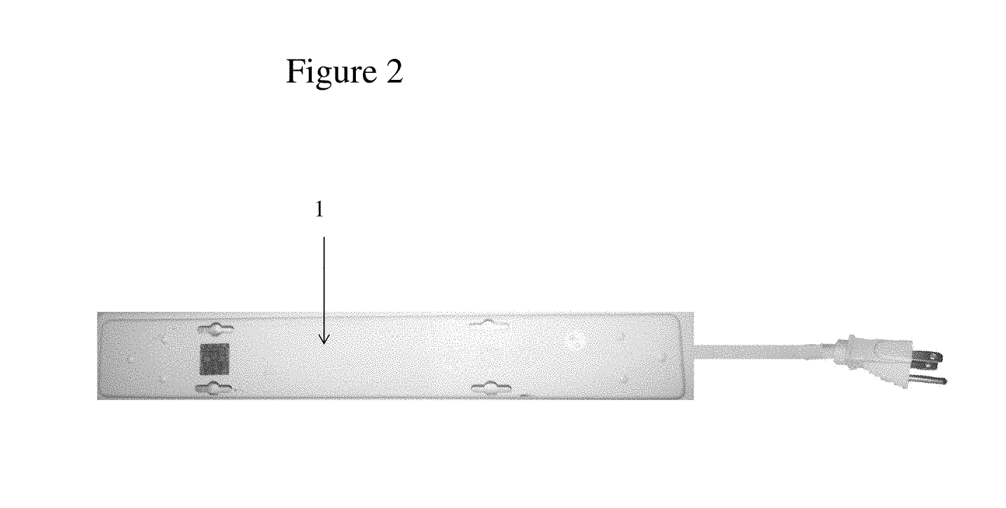

Referring to FIG. 2 of the drawings, for identification purposes, please locate the power strip showing items 1 identifying the bottom of the power strip.

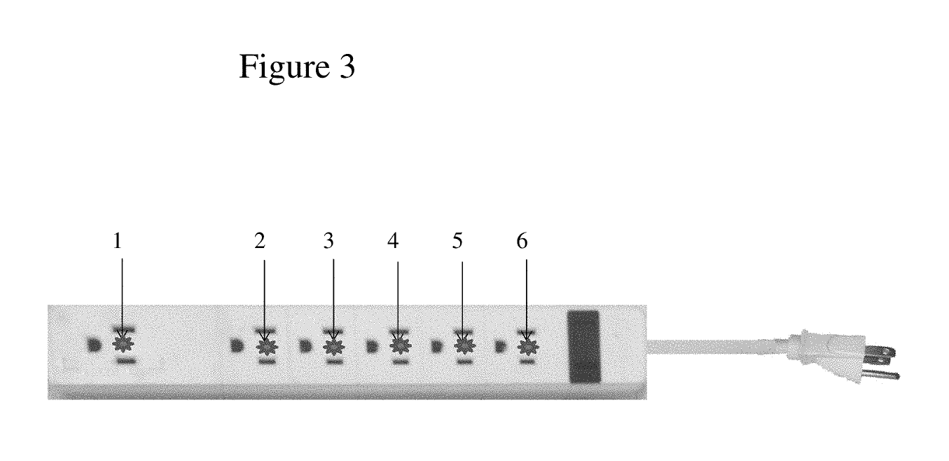

Referring to FIG. 3 of the drawings showing Items 1 through 6 being S-LIGHT indicators strategically located under the plug. If a plug is plugged into the socket, S-LIGHT will be covered up by plug thus not visible. This method provides a simple means of blocking the S-LIGHT rather than turning it off.

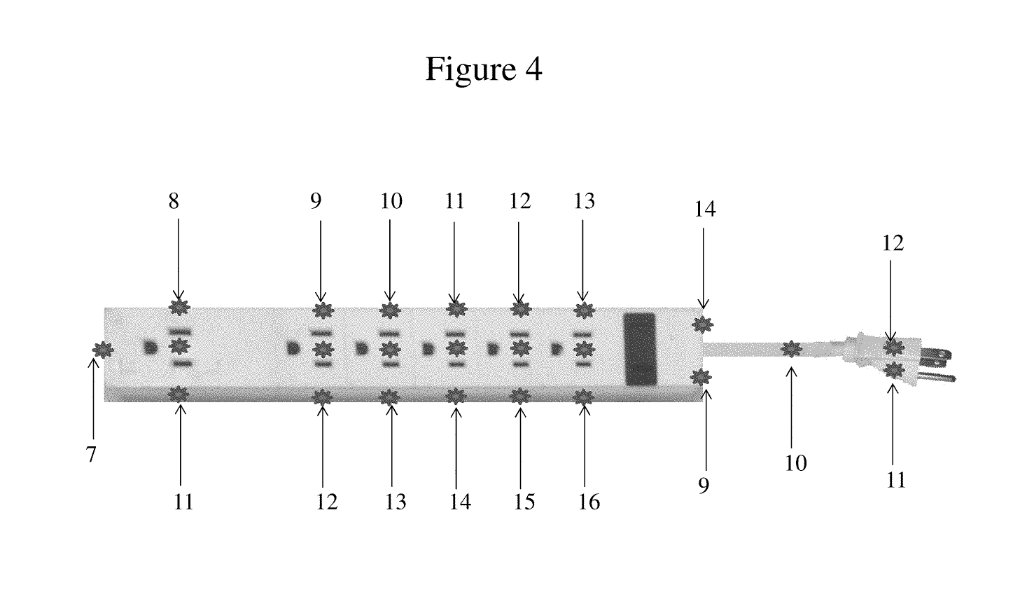

Referring to FIG. 4 of the drawings showing Items 1 through 14 being S-LIGHT indicators on a variety of the power strip. These locations do not indicate a limiting factor in placement but provide a sample of various location options.

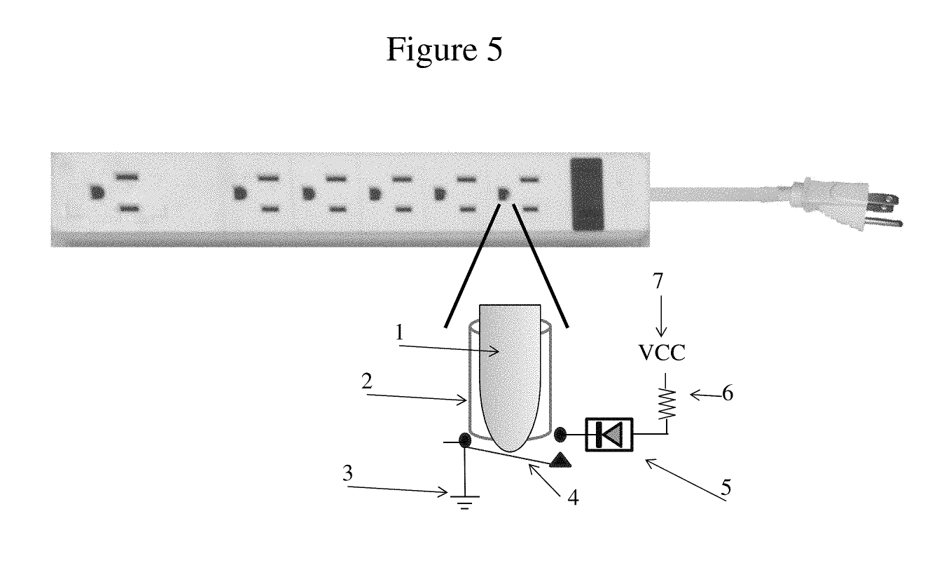

Referring to FIG. 5 of the drawings, please locate item 1 being the ground pin of a Plug being plugged into the power strip, Items 2 being the ground pin receptacle, Item 3 being circuit ground for S-LIGHT electronics, Item 4 being the switch to remove the ground for S-LIGHT electronics, Item 5 being the S-LIGHT active, Item 6 being resistor for S-LIGHT electronics, Item 7 being a supply voltage for S-LIGHT electronics.

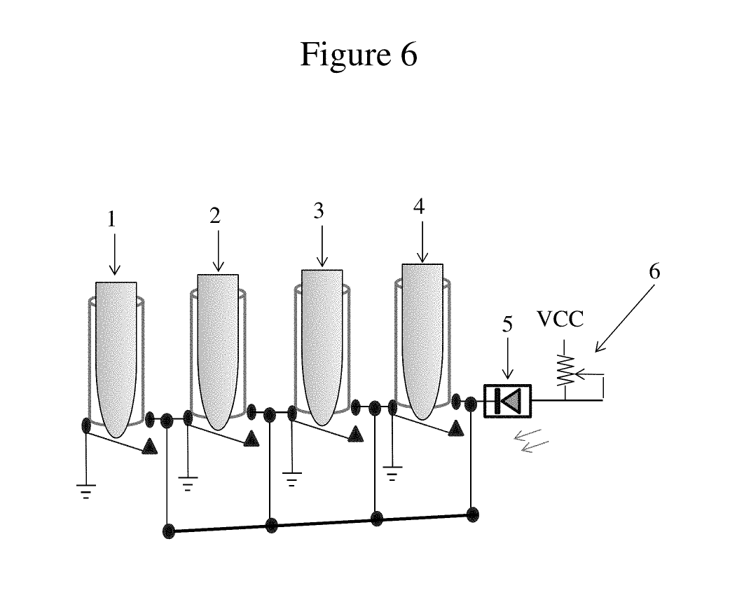

Referring to FIG. 6 of the drawings, please locate items 1 through 4 being the ground pin of a Plug being plugged into the power strip causing the device to become active, Items 5 representing one or more active or inactive S-LIGHT, item 6 representing an adjustable resistor for lumen adjustment.

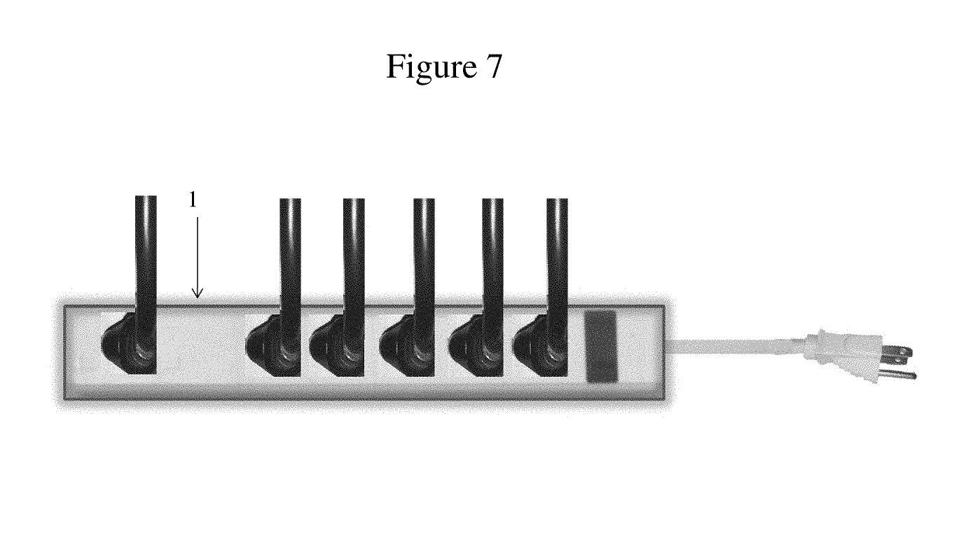

Referring to FIG. 7 of the drawings, please locate items 1 indicating the S-Light being active and case glowing red indicating there are no available sockets.

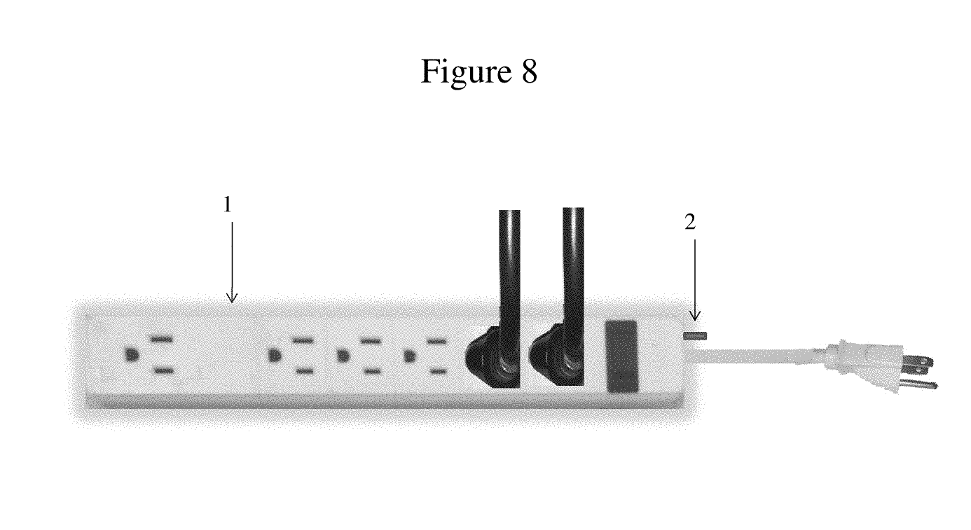

Referring to FIG. 8 of the drawings, please locate items 1 indicating the S-Light being active and case glowing green indicating available sockets. Item 2 shows a knob to adjust lumen brightness.

The power strip shown in the figures is used as a common device and is one of several various forms, size and functions, being manufactured and should not be construed as a limiting factor in the overall objective being claimed. Enumeration of S-LIGHT within this document should not be construed as a limiting factor of number, size, shape, or location of S-LIGHT. Any electronic method shown of S-LIGHT activation or de-activation should not be construed as a limiting factor in method but to provide a simple method to understanding operation. Use of a ground pin for activation or de-activation should not be construed as a limiting factor. Other pins and numerous methods to obtain activation and deactivation exist.

What is claimed is:

1. A power strip configuration comprising visible radiation as a socket availability indicator.

2. The system according to claim 1 where visible radiation exists on any portion of the power strip.

3. The system according to claim 1 where visible radiation may be disabled by any means.

4. The system according to claim 1 where visible radiation may be enabled by any means.

5. The system according to claim 1 where visible radiation may become active if one or more sockets are vacant.

6. The system according to claim 1 where visible radiation may become inactive if one or more sockets are vacant.

7. The system according to claim 1 where any method may be used to cause visible radiation to become active or inactive.

8. The system according to claim 1 where any method may be used to cause visible radiation to become more or less luminous.
